(19) United States
(12) Patent Application Publication
(10) Pub. No.: US 2026/0227073 A1
(43) Pub. Date: Aug. 6, 2026

(54) COMBINATION OVEN WITH TIME-BASED HUMIDITY STEAM CONTROL

(71) Applicant: ILLINOIS TOOL WORKS INC., Glenview, IL (US)

(72) Inventors: Gopinath PRAKASAM, Plain City, OH (US); David SAGER, Troy, OH (US); Jarrad A. JOHNSON, Troy, OH (US); Christopher S. HOPPER, Dayton, OH (US); Henry G. SAWTELLE, Portland, OR (US)

(21) Appl. No.: 19/047,206

(22) Filed: Feb. 6, 2025

(51) Int. Cl. F24C 15/00; F24C 15/20; F24C 15/32

(52) U.S. Cl. CPC F24C 15/003; F24C 15/2007; F24C 15/2021; F24C 15/322

(57) ABSTRACT

An oven includes a housing defining a cooking cavity, the cooking cavity accessible via a door that is movable between an open position and a closed position relative to the cooking cavity. A steam generator is connected for delivering steam into the cooking cavity. A controller is configured for controlling operation of the steam generator during an initiated item cooking process such that ON and OFF operation of the steam generator is (i) carried out without reference to a humidity sensor or pressure sensor and (ii) based upon predetermined times that are tied to a humidity setting.

### TECHNICAL FIELD

This application relates generally to ovens that utilize a steam generator to feed steam into an oven cavity and, more specifically, to combination ovens that control humidity to achieve a better cooking result.

### BACKGROUND

Combination ovens commonly include a cooking cavity with an associated heating device (e.g., resistive heating element(s) or combustion gas heat exchange tube(s)) and a steam generator to deliver steam into the cooking cavity. In the past, traditional methods to control humidity in the cooking cavity of such ovens involved using a humidity sensor to measure the humidity in the cavity, or a pressure sensor to measure the pressure difference caused by an increase in humidity or a change in temperature. Simplifying the humidity control would be beneficial.

Accordingly, it would be desirable to provide an oven with a humidity control system that does not require the use of a humidity sensor or pressure sensor.

### SUMMARY

In one aspect, in an oven including a cooking cavity and a steam generator connected for delivering steam into the cooking cavity, a method of controlling steam production and delivery from the steam generator into the cavity without use of a humidity sensor or pressure sensor is provided. The method involves: upon initiation of a cooking process for an item in the cooking cavity, controlling an ON or OFF condition of the steam generator based upon predetermined times that are tied to a humidity setting for the cooking process.

In implementations, the controller includes associated memory, wherein the controller is configured enable operator selection of the humidity setting, wherein the controller is configured to retrieve the predetermined times based upon the selected humidity setting.

In another aspect, an oven includes a housing defining a cooking cavity, the cooking cavity accessible via a door that is movable between an open position and a closed position relative to the cooking cavity. A steam generator is connected for delivering steam into the cooking cavity. A controller is configured for controlling operation of the steam generator during an initiated item cooking process such that ON and OFF operation of the steam generator is (i) carried out without reference to a humidity sensor or pressure sensor and (ii) based upon predetermined times that are tied to a humidity setting for the item cooking process.

In another aspect, in an oven including a cooking cavity and a steam generator connected for delivering steam into the cooking cavity, a method of controlling steam production and delivery from the steam generator into the cavity without use of a humidity sensor or pressure sensor is provided, where the method involves: turning ON the steam generator for a predetermined initial time period that is tied to a humidity setting for the cooking process; and after the predetermined initial time period, carrying out a repeating cycle of OFF/ON operation of the steam generator based upon a predetermined OFF time for the repeating cycle and a predetermined ON time for the repeating cycle, wherein the predetermined OFF time and the predetermined ON time are tied to the humidity setting for the cooking process.

In implementations, the oven includes a controller with associated memory, wherein the controller is configured to enable operator selection of at least a first humidity setting, a second humidity setting and a third humidity setting, wherein the second humidity setting is between the first humidity setting and the second humidity setting. The memory stores a first predetermined initial time period tied to the first humidity setting, a second predetermined initial time period tied to the second humidity setting and a third predetermined initial time period tied to the third humidity setting. The humidity setting and predetermined initial time period are one of: the first humidity setting and the first predetermined initial time period; the second humidity setting and the second predetermined initial time period; or the third humidity setting and the third predetermined initial time period.

In implementations, the second predetermined time period is longer than the first predetermined time period and shorter than the third predetermined time period, wherein the first humidity setting is a low humidity range, the second humidity setting is a medium humidity range, and third humidity setting is a high humidity range.

In implementations, the memory stores a first predetermined OFF time tied to the first humidity setting, a second predetermined OFF time tied to the second humidity setting and a third predetermined OFF time tied to the third humidity setting; the memory stores a first predetermined ON time tied to the first humidity setting, a second predetermined ON time tied to the second humidity setting and a third predetermined ON time tied to the third humidity setting; wherein the predetermined OFF time for the repeating cycle and the predetermined ON time for the repeating cycle are one of: the first predetermined OFF time and the first predetermined ON time; the second predetermined OFF time and the second predetermined ON time; or the third predetermined OFF time and the third predetermined ON time.

In implementations, the oven includes a vent intake to the cooking cavity and an exhaust path from the cooking cavity, the vent intake including an associated air mover, wherein, after each predetermined ON time of the repeating cycle, the air mover of the vent intake is operated for a set time period to move ambient air into the cooking cavity and force at least some steam in the cooking cavity to exit the cooking cavity via the exhaust path.

In implementations, the oven includes a controller with associated memory, wherein the controller is configured to enable operator selection of the humidity setting, wherein a set minimum temperature for water in the steam generator is maintained, wherein the set minimum temperature is tied to the humidity setting, wherein each of the predetermined initial time period, the predetermined OFF time, the predetermined ON time and the set minimum temperature are stored in memory.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic depiction of a combination oven;

FIG. 2 depicts an exemplary steam production process;

FIGS. 3-5 show exemplary steam production for low, medium and high humidity settings; and

FIG. 6 show an exemplary air intake operation.

### DETAILED DESCRIPTION

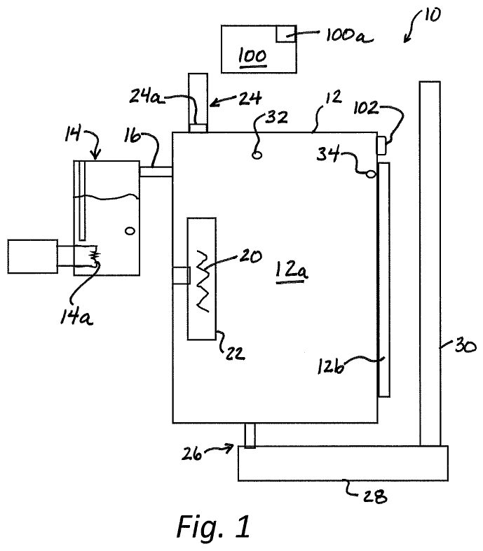

Referring to FIG. 1, a schematic depiction of a combination oven 10 is shown. The combination oven includes a housing 12 defining a cooking cavity 12a, the cooking cavity accessible via a door 12b that is movable between an open position and a closed position relative to the cooking cavity. A steam generator 14 (e.g., tank with internal heating device 14a and water level probe 14b) is connected for delivering steam into the cooking cavity (e.g., via steam delivery path 16). The heating device 14a may be a resistive heating element or may be a heat exchange tube with a controllable a gas burner. The cooking cavity 12a includes a heating device 20, in the form of a heat exchange tube or tubes with associated controllable gas burner(s) or in the form of one or more resistive heating elements, within the cooking cavity, and an air mover (e.g. fan/impeller with associated motor) 22 within the cooking cavity. An air intake vent 24 to the cooking cavity 12a includes an associated air mover 24a that can be operated to move ambient air into the cooking cavity 12a. An exhaust path 26 from the cooking cavity 12a may pass through a drain box 28 and then to a vent stack 30. A cooking cavity temperature sensor 32, a door sensor 34 and a steam generator water temperature sensor 34 may also be provided.

The oven includes a controller 100 with associated memory 100a, where the controller is configured for controlling the oven components (e.g., the steam generator 14, the heating device 20, air mover 22 and air intake vent 24) in preparation for and during a cooking process for items in the cooking cavity. The controller may also be associated with a user interface 102 (e.g., a touch-screen display and/or one or more buttons or knobs) of the oven. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group-including hardware or software that executes code), software, firmware and/or other components, or a combination of some or all of the above, that carries out the control functions of the machine or the control functions of any component thereof.

Notably, the controller 100 is configured for controlling operation of the steam generator 14 during an initiated item cooking process such that ON and OFF operation of the steam generator is (i) carried out without reference to a humidity sensor or pressure sensor and (ii) based upon predetermined times that are tied to a humidity setting for the item cooking process. This simplifies the oven and oven control. Below, the specifics of one example of such oven and steam generator control operation are described.

An operator is able to use the interface 102 to set the desired humidity for the cooking cavity 12a to one of a number of ranges (e.g., a low humidity setting being 10%-30% humidity, a medium humidity setting being 40%-65% humidity and a high humidity setting being above 85% humidity). The desired cook temperature for the cooking cavity 12a can also be set via the interface 102.

Depending on the humidity range selected, a maintenance temperature for the water in the steam generator is defined by the oven controller (e.g., by retrieval from memory based upon the selected humidity setting range; e.g., 190F for the low humidity setting, 200F for the medium humidity setting and 208F for the high humidity setting). Once the humidity setting is selected, the steam generator heating device 14a is controlled to assure that the water temperature is at least at the maintenance temperature. After the maintenance temperature for the steam generator water is reached, and to bring the cooking cavity 12a up to its set cooking temperature at start-up, the steam generator 14 is turned On (i.e., heating device 14a on) to deliver steam into the cooking cavity, and the cavity heating device 20 is maintained OFF, until the temperature in the cooking cavity reaches a predefined temperature TMP1 that is below the set cook temperature for the cooking cavity (e.g., in the case of the low humidity setting the predefined temperature may be 140F, in the case of the medium humidity setting the predefined temperature may be 185F and in the case of the high humidity setting the predefined temperature may be 205F). Once the cooking cavity reaches the predefined temperature, the steam generator 14 is turned OFF, and the heating device 20 is turned ON to bring the cavity 12a the rest of the way up to the set cook temperature. The oven is then ready for cooking.

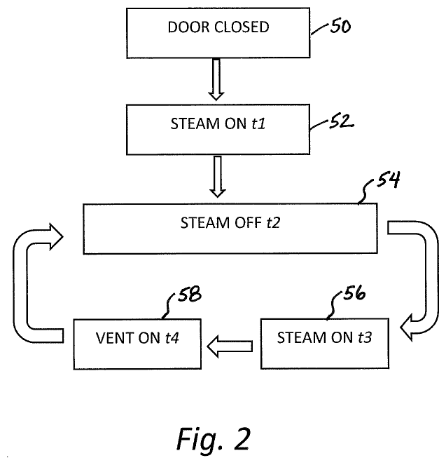

Here, cooking process is initiated by opening and closing the door 12b to the cavity (e.g., as occurs when a food item is placed into cavity 12a). In other embodiments, the cooking operation could be otherwise initiated (e.g., by a button press). As shown in FIG. 2, the closure of the door/initiation of the cooking process, per step 50, triggers an initial steam generator turn ON step 52 for a predetermined initial time period t1 that is based on the humidity setting (e.g., ON 10 seconds for the low humidity setting, ON 30 seconds for the medium humidity setting and ON for 80 seconds for the high humidity setting). Per steps 54-58, a repeating cycle of OFF and ON times t2 and t3 for the steam generator 14 are then carried out during the cooking process, as well as vent intake operation for time t4. The cooking process may, for example, be carried out for a defined time period or until a food temperature probe indicates that cooking is complete.

Exemplary time periods t2, t3 and t4 of the repeating cycle, for the selectable humidity settings, are shown in the table below, along with other settings that are tied to the selected humidity setting, but other variations are possible. The appropriate values to achieve and maintain the selected humidity setting for any given oven can be determined by advance testing of the oven, and then stored in memory associated with the oven controller. The values can then be retrieved by the controller, for use in a cooking operation, based upon the selected humidity setting for the cooking operation. An exemplary set of values are set forth in Table 1 below.

TABLE 1
Exemplary Controller Memory Settings

| Selected | | | | | | |
|---|---|---|---|---|---|---|
| Humidity Setting | Low | | Medium | | High | |
| Corresponding | 10-30% | | 40-65% | | >85% | |
| Target Humidity | | | | | | |
| Range | | | | | | |
| Maint. Temp | 190 F | | 200 F | | 208 F | |
| TMP1 | 135 F-145 F | | 180-195 F | | 205 F | |
| t1 | 8-12 | secs | 25-35 | secs | 75-85 | secs |
| t2 | 220-260 | secs | 220-260 | secs | 75-85 | secs |
| t3 | 7-9 | secs | 11-13 | secs | 11-13 | secs |
| t4 | 3 | secs | 3 | secs | 0 | secs |

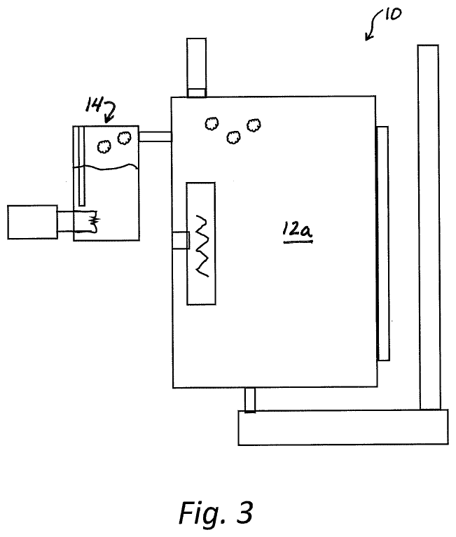

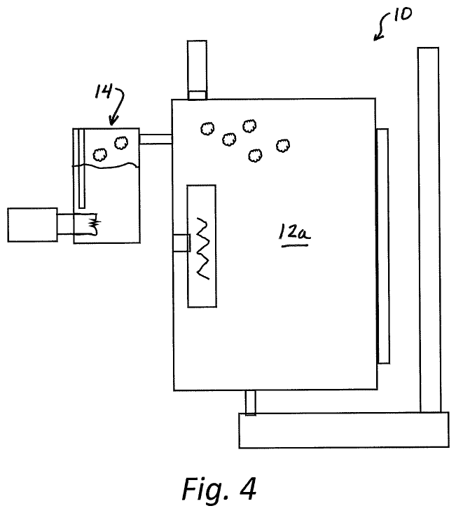

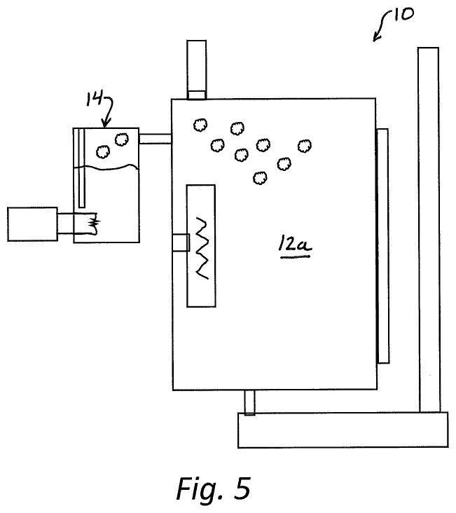

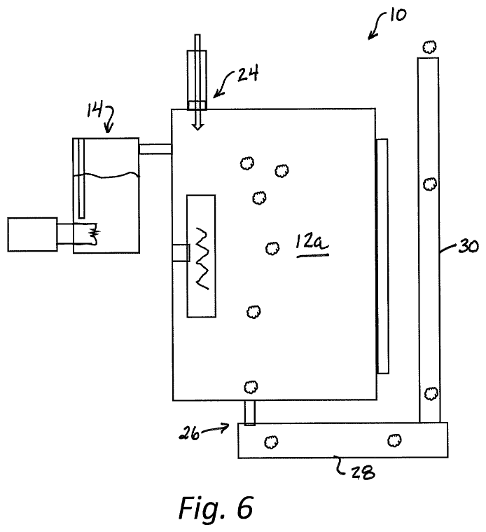

FIGS. 3-5 depict exemplary steam production and delivery to the cooking cavity during the On time of the repeating cycle for the low, medium and high humidity settings respectively. FIG. 6 depicts an exemplary intake vent operation to remove some steam from the cooking cavity.

It is to be clearly understood that the above description is intended by way of illustration and example only, is not intended to be taken by way of limitation, and that other changes and modifications are possible. For example, less or more than three humidity setting ranges could be utilized (e.g., two humidity setting ranges or four humidity setting ranges).

1. In an oven including a cooking cavity and a steam generator connected for delivering steam into the cooking cavity, a method of controlling steam production and delivery from the steam generator into the cavity without use of a humidity sensor or pressure sensor, the method comprising the steps of:
turning ON the steam generator for a predetermined initial time period that is tied to a humidity setting for the cooking process;
after the predetermined initial time period, carrying out a repeating cycle of OFF/ON operation of the steam generator based upon a predetermined OFF time for the repeating cycle and a predetermined ON time for the repeating cycle, wherein the predetermined OFF time and the predetermined ON time are tied to the humidity setting for the cooking process.

2. The method of claim 1, wherein:
the oven includes a controller with associated memory, wherein the controller is configured enable operator selection of the humidity setting, wherein the controller is configured to retrieve the predetermined initial time, the predetermined OFF time and the predetermined ON time from memory based upon the selected humidity setting.

3. The method of claim 1, wherein:
the oven includes a controller with associated memory, wherein the controller is configured to enable operator selection of at least a first humidity setting, a second humidity setting and a third humidity setting, wherein the second humidity setting is between the first humidity setting and the second humidity setting;
the memory stores a first predetermined initial time period tied to the first humidity setting, a second predetermined initial time period tied to the second humidity setting and a third predetermined initial time period tied to the third humidity setting;
wherein the humidity setting and the predetermined initial time period are one of:
the first humidity setting and the first predetermined initial time period;
the second humidity setting and the second predetermined initial time period; or
the third humidity setting and the third predetermined initial time period.

4. The method of claim 3, wherein the second predetermined time period is longer than the first predetermined time period and shorter than the third predetermined time period, wherein the first humidity setting is a low humidity range, the second humidity setting is a medium humidity range, and third humidity setting is a high humidity range.

5. The method of claim 4, wherein:
the memory stores a first predetermined OFF time tied to the first humidity setting, a second predetermined OFF time tied to the second humidity setting and a third predetermined OFF time tied to the third humidity setting;
the memory stores a first predetermined ON time tied to the first humidity setting, a second predetermined ON time tied to the second humidity setting and a third predetermined ON time tied to the third humidity setting;
wherein the predetermined OFF time for the repeating cycle and the predetermined ON time for the repeating cycle are one of:
the first predetermined OFF time and the first predetermined ON time;
the second predetermined OFF time and the second predetermined ON time; or
the third predetermined OFF time and the third predetermined ON time.

6. The method of claim 1, wherein the oven includes a vent intake to the cooking cavity and an exhaust path from the cooking cavity, the vent intake including an associated air mover, wherein, after each predetermined ON time of the repeating cycle, the air mover of the vent intake is operated for a set time period to move ambient air into the cooking cavity and force at least some steam in the cooking cavity to exit the cooking cavity via the exhaust path.

7. The method of claim 1, wherein the oven includes a controller with associated memory, wherein the controller is configured to enable operator selection of the humidity setting, wherein a set minimum temperature for water in the steam generator is maintained, wherein the set minimum temperature is tied to the humidity setting, wherein each of the predetermined initial time period, the predetermined OFF time, the predetermined ON time and the set minimum temperature are stored in memory.

8. In an oven including a cooking cavity and a steam generator connected for delivering steam into the cooking cavity, a method of controlling steam production and delivery from the steam generator into the cavity without use of a humidity sensor or pressure sensor, the method comprising the steps of:
upon initiation of a cooking process for an item in the cooking cavity, controlling an ON or OFF condition of the steam generator based upon predetermined times that are tied to a humidity setting for the cooking process.

9. The method of claim 8, wherein:
the oven includes a controller with associated memory, wherein the controller is configured enable operator selection of the humidity setting, wherein the controller is configured to retrieve the predetermined times from memory based upon the selected humidity setting.

10. The method of claim 8, wherein the method includes:
during at least part of the cooking process, carrying out a repeating cycle of OFF/ON operation of the steam generator based upon a predetermined OFF time for the repeating cycle and a predetermined ON time for the repeating cycle, wherein the predetermined OFF time and the predetermined ON time are tied to the humidity setting for the cooking process.

11. The method of claim 10, wherein the oven includes a vent intake to the cooking cavity and an exhaust path from the cooking cavity, the vent intake including an associated air mover, wherein, after each predetermined ON time of the repeating cycle, the air mover of the vent intake is operated for a set time period to move ambient air into the cooking cavity and force at least some steam in the cooking cavity to exit the cooking cavity via the exhaust path.

12. The method of claim 10, wherein the oven includes a controller with associated memory, wherein the controller is configured to enable operator selection of the humidity setting, wherein a set minimum temperature for water in the steam generator is maintained, wherein the set minimum temperature is tied to the humidity setting, wherein each of the predetermined OFF time, the predetermined ON time and the set minimum temperature are stored in memory.

13. The method of claim 10, wherein:
the oven includes a controller with associated memory, wherein the controller is configured to enable operator selection of at least a first humidity setting, a second humidity setting and a third humidity setting, wherein the second humidity setting is between the first humidity setting and the second humidity setting;
the memory stores a first predetermined OFF time tied to the first humidity setting, a second predetermined OFF time tied to the second humidity setting and a third predetermined OFF time tied to the third humidity setting;
the memory stores a first predetermined ON time tied to the first humidity setting, a second predetermined ON time tied to the second humidity setting and a third predetermined ON time tied to the third humidity setting;
wherein the predetermined OFF time for the repeating cycle and the predetermined ON time for the repeating cycle are one of:
the first predetermined OFF time and the first predetermined ON time;
the second predetermined OFF time and the second predetermined ON time; or
the third predetermined OFF time and the third predetermined ON time.

14. An oven, comprising:
a housing defining a cooking cavity, the cooking cavity accessible via a door that is movable between an open position and a closed position relative to the cooking cavity;
a steam generator connected for delivering steam into the cooking cavity;
a controller configured for controlling operation of the steam generator during an initiated item cooking process such that ON and OFF operation of the steam generator is (i) carried out without reference to a humidity sensor or pressure sensor and (ii) based upon predetermined times that are tied to a humidity setting for the item cooking process.

15. The oven of claim 14, wherein:
wherein the controller includes associated memory, wherein the controller is configured enable operator selection of the humidity setting, wherein the controller is configured to retrieve the predetermined times based upon the selected humidity setting.

16. The oven of claim 14, wherein the controller is configured such that:
during at least part of the cooking process, a repeating cycle of OFF/ON operation of the steam generator is carried out based upon a predetermined OFF time for the repeating cycle and a predetermined ON time for the repeating cycle, wherein the predetermined OFF time and the predetermined ON time are tied to the humidity setting for the cooking process.

17. The oven of claim 16, wherein the oven includes a vent intake to the cooking cavity and an exhaust path from the cooking cavity, the vent intake including an associated air mover, wherein the controller is configured such that, after each predetermined ON time of the repeating cycle, the air mover of the vent intake is operated for a set time period to move ambient air into the cooking cavity and force at least some steam in the cooking cavity to exit the cooking cavity via the exhaust path.

18. The oven of claim 16, wherein the controller includes associated memory, wherein the controller is configured to enable operator selection of the humidity setting, wherein the controller is configured such that a set minimum temperature for water in the steam generator is maintained, wherein the set minimum temperature is tied to the humidity setting, wherein each of the predetermined OFF time, the predetermined ON time and the set minimum temperature are stored in memory.
